(19) United States
(12) Patent Application Publication
(10) Pub. No.: US 2019/0122314 A1
(43) Pub. Date: Apr. 25, 2019

(54) Method and system of providing homemade food via an online marketplace

(71) Applicant: Wensheng Vincent Kuang, Valencia, CA (US)

(72) Inventor: Wensheng Vincent Kuang, Valencia, CA (US)

(21) Appl. No.: 15/791,419

(22) Filed: Oct. 24, 2017

(51) Int. Cl. G06Q 50/12; G06Q 20/12; G06Q 30/06

(52) U.S. Cl. CPC G06Q 50/12; G06Q 30/0641; G06Q 20/12

(57) ABSTRACT

Method and system for providing homemade food via an online marketplace are disclosed. The food is made in residential homes by skilled home cookers, who share the kitchens and cooking skills with the local community by providing the homemade food via the online marketplace. For the consumers, the online marketplace provides an easy access to wide variety of foods at lower prices.

### FIELD OF THE INVENTION

This invention relates generally to providing food via an online marketplace, and particularly to providing homemade food via an online marketplace.

### BACKGROUND OF THE INVENTION

Shared economy via online marketplaces has been widely successful, for example, Uber for car-sharing and AirBnB for room-sharing. The basic idea is to make use of idle economical resources that had been wasted due to lack of a marketplace that allows potential customers to access the resources. Online marketplaces open opportunities to realize the economical potential of various idle resources in the economy.

Food sharing looks like a logical choice after successful car-sharing and room-sharing. Obviously, a lot, if not most, of the food that are consumed are made and consumed at home. Every home has a kitchen and a lot of homeworkers are skilled cookers. Most of the kitchens in residential homes are idle except around the meal time, and home cookers are certainly able to make more food if there is demand and a working marketplace. Compared to food provided in commercial restaurants, residential homemade food can be cheap because the land and cooking equipment are shared resources, and rich in variety simply because there are so many home cookers out there. And there certainly are many people who are not skilled in cooking and would rather get food from skilled home cookers in the residential community if such an option is available.

It therefore makes sense economically to provide homemade food via an online marketplace.

### SUMMARY OF THE INVENTION

Method and system for providing homemade food via an online marketplace are described. The food is made in residential homes by skilled home cookers, who share the kitchens and cooking skills with the local community by providing the homemade food via the online marketplace. The online marketplace provides customers an easy access to the homemade food at lower prices.

Other objectives and further advantages and benefits associated with this invention will be apparent to those skilled in the art from the description, examples, and claims that follow.

### BRIEF DESCRIPTION OF THE DRAWINGS

Preferred forms of the invention are described with reference to the accompanying drawings.

FIG. 1 shows an online marketplace with homemade food provided to customers according to the present invention;

FIG. 2 is a flow diagram of a process in which a homemade food is ordered by and delivered to a customer in an online marketplace according to the present invention.

### DETAILED DESCRIPTION OF THE INVENTION

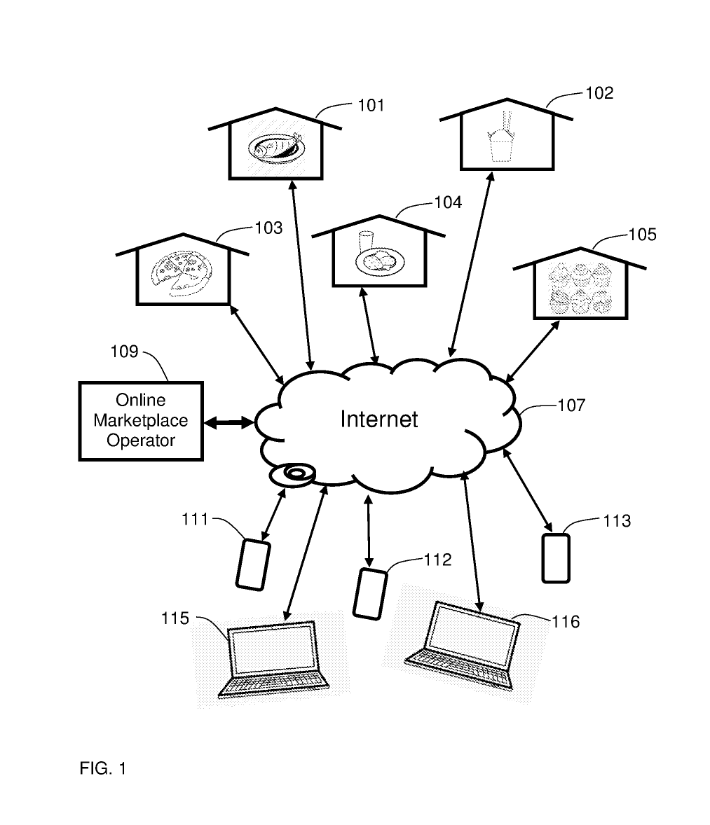

Referring to FIG. 1, an online marketplace with homemade food provided from residential homes to customers according to the invention is shown. The food is made in residential homes 101-105, which are connected to the internet 107. The information about the homemade food are put on the internet and made accessible by the market operator 109 to customers via their mobile phones 111-113 and computers 115-116.

The online marketplace can be implemented as a website that serves as a platform where homemade food providers and consumers interact in a way that is mutually beneficial. For the food providers, the online marketplace is a home business sales channel. For the consumers, the online marketplace provides an easy access to wide variety of foods at lower prices.

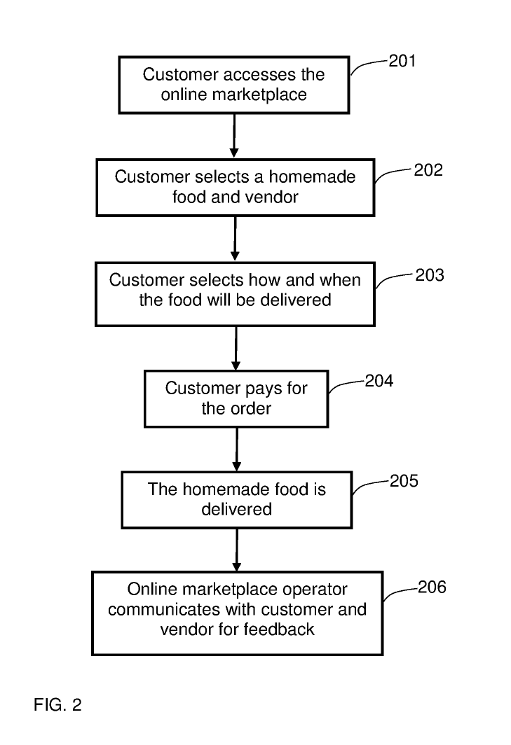

FIG. 2 is a flow diagram of a process in which a homemade food is ordered by and delivered to a customer in an online marketplace according to the present invention. At step 201, the customer visits the online marketplace operator or host web site to gain access to the homemade food. At step 202 the customer selects a homemade food and vendor. At step 203 the customer selects how and when the food shall be delivered or picked up. The delivery or the pickup can be completed by the customer or someone else arranged by the customer. At step 204 the customer pays for the food. After the food is delivered or picked up in step 205, at step 206 the online marketplace operator communicates with the customer and vendor for inputs and feedback about the food and the service.

The invention has been described in preferred forms and method by way of examples. It will be understood by those skilled in the art that various changes and modifications may be made to the embodiments without departing from the spirit or scope of the invention. It is not intended that the invention be limited in any way to the embodiments shown and described herein and it is intended that the invention be limited only by the claims appended hereto.

What is claimed is:

1. A method of providing homemade food via an online marketplace, the method comprising:
enabling a customer in the online marketplace to access the homemade food that is made in residential homes;
enabling the customer to select a homemade food from a plurality of homemade food vendors;
arranging delivery or pickup of the food selected by the customer;
processing a transaction for the food between the customer and a vendor that is selected by the customer;
accepting a payment from the customer for the food; and
communicating to the vendor and the customer information relating to the transaction.

2. The method of claim 1 wherein said food selected and paid for by the customer is delivered to or picked up by the customer or someone in the local area where the homemade food is made in said residential homes.

3. The method of claim 1 further comprising accepting feedback input from the customer relating to the food and service.

4. The method of claim 1 further comprising accepting feedback input from the vendor about the customer.

5. The method of claim 1 further comprising processing the feedback input from the customer and assimilating the feedback input into informational content associated with the vendor.

6. A system for providing homemade food via an online marketplace, the system comprising:
one or more processors; and
at least one memory accessible by the one or more processors, the memory storing program codes for:
enabling a customer in the online marketplace to access the homemade food that is made in residential homes;
enabling the customer to select a homemade food from a plurality of homemade food vendors;
arranging delivery or pickup of the food selected by the customer;
processing a transaction for the food between the customer and a vendor that is selected by the customer;
accepting a payment from the customer for the food; and
communicating to the vendor and the customer information relating to the transaction.

7. The system of claim 6 wherein said homemade food is made in residential homes.

8. The system of claim 6 wherein said memory further stores programming instructions for accepting feedback input from the customer relating to the food and service.

9. The system of claim 6 wherein said memory further stores programming instructions for accepting feedback input from the vendor about the customer.

10. The system of claim 6 wherein said memory further stores programming instructions for processing the feedback input from the customer and assimilating the feedback input into informational content associated with the vendor.
